(19) United States
(12) Patent Application Publication
(10) Pub. No.: US 2002/0137012 A1
(43) Pub. Date: Sep. 26, 2002

(54) Programmable self-teaching audio memorizing aid

(76) Inventor: G. Burnell Hohl, New Canaan, CT (US)

Correspondence Address: James G. Coplit, Esq., GRIMES & BATTERSBY, Post Office Box 1311, Stamford, CT, 06904-1311, US

(21) Appl. No.: 10/083,770

(22) Filed: Feb. 26, 2002

Related U.S. Application Data
(60) Provisional application No. 60/272,879, filed on Mar. 5, 2001.

(51) Int. Cl. G09B 19/00

(52) U.S. Cl. 434/156

(57) ABSTRACT

A programmable electronic device is provided for storing, retrieving and playing back audio information stored as audio information pairs within an analog or digital voice memory. The audio information pairs are stored as voice records and are ordered in a queue, with each record being individually addressable by a microcontroller and a voice record pointer. Individual audio information pairs may be randomly selected by the microcontroller or, alternatively, sequentially selected in the order they were stored in the queue. Either the first or second audio segment in the audio information pair may be played and, if the information contained in the corresponding segment is known (for example the word's definition or the state's capital), the record may be removed from the queue and another audio information pair accessed. Alternatively, if the information from the corresponding record is not known, the corresponding audio segment may be played, and the audio information pair placed back in the queue. Each audio information pair may be edited and new pairs added by means of a microphone, or, alternatively, from an external source such as a CD-ROM or a database accessed over a computer network such as the Internet

### BACKGROUND OF THE INVENTION

1. Field of the Invention

The present invention relates generally to electronic learning/memorizing aids and audio recorders and, more particularly, to an electronic audio recording/playback device to facilitate the study and memorization of ordered pairs of information such as vocabulary words and their definitions, foreign language words and translations, associated facts, words and their spelling, and math problems and answers.

2. Description of the Prior Art

The use of electronic means for recording and playing back voice, music and other sounds has long been known. Until fairly recently, such means typically consisted of a device that used recording media such as phonograph record or magnetic tapes upon which the audio input was stored and/or played back in an analog format. Digital, electronic and solid state voice recorders have been developed to record and playback messages and other audio information with significant advantages over traditional magnetic tape-based devices. Such recorders may be made extremely small and compact, and can be used to access various recorded messages instantly without the delays inherent in tape-based devices due to the sequential access nature of tape media. Despite the facility and speed with which digital recorders may access audio information at any location in their memory, however, these recorders, are not designed to record and play back associated facts, or words and their definitions, as ordered audio pairs that can be randomly accessed to facilitate the memorizing of such facts or vocabulary words.

Some attempts to create text-based memorizing aids are shown in the prior art, particularly for the learning of foreign language. U.S. Pat. No. 4,143,473, which issued to Mitsuya on Mar. 13, 1979 for a “Memorizing Aid” shows a device which mimics the functionality of flash cards using a visual tape mechanism that can be moved forwards or backwards to reveal various printed foreign language words and their English equivalents. Another example of a learning aid is shown in U.S. Pat. No. 3,696,526, which issued to Roeder, et al. on Oct. 10, 1972 for an “Educational Testing and Instructional Device” and describes an educational testing device also using a moveable tape with correlated indicia visible through view openings.

Flashcards are often used in memorizing paired facts such as definitions or translations. U.S. Pat. No. 5,494,444, which issued to Thayer, et al. on Feb. 27, 1996 for “Method of Simulating Flashcards for Learning Purposes” discloses the use of a computer for displaying a plurality of information elements, each having a first cue portion and a related second response portion.

Electronic translators have been used as language learning aids. For example, the electronic translator described in U.S. Pat. No. 4,509,137, which issued to Yoshida on Apr. 2, 1985 for a “Language Translator with Random Generation of Test Words During Learning Mode” can function as a language learning aid by sequentially retrieving a plurality of words in a first language, and allowing the user to enter the words considered to be the equivalent of the translated words to check his knowledge of the words.

There are also digital sound storage devices that can record and playback foreign language phrases to aid the student in improving pronunciation and in comparing his/her speech against that of a native speaker. For example, U.S. Pat. No. 5,056,145, which issued to Yamamoto et al. on Oct. 8, 1991 for a “Digital Sound Data Storing Device” discloses a portable digital sound storing device that can playback speech of two languages recorded on a detachable memory card.

While electronic translators and memorization aids are well known in the prior art, there is a need for a compact, convenient, and easy-to-use electronic audio recorder that is specifically designed for use as a memorizing aid, with features that simulate well-known learning methods using a stack of dual-sided flash cards.

### SUMMARY OF THE INVENTION

Against the foregoing background, it is a primary object of the present invention to provide an electronic learning tool for use in memorizing ordered pairs of facts or information such as vocabulary words, foreign language, associated facts (such as states and their capital cities), spelling, and math.

It is another object of the present invention to provide such a learning tool that is portable.

It is yet another object of the present invention to provide such a learning tool that is convenient to use.

It is still another object of the present invention to provide such a learning tool that may be programmed by a user.

It is but another object of the present invention to provide such a learning tool that includes an audio recording feature for storing and playing back audio information, such as a list of vocabulary words and their definitions.

It is yet still another object of the present invention to provide such a learning tool that is adapted to retrieve the recorded audio ordered pairs in sequential order so that particular entries may be edited, or additional audio information pairs added at the end of a previously recorded list.

It is another object of the present invention to provide such a learning tool that is adapted to retrieve randomly and independently each half of the stored audio ordered pairs, in a self-test mode of operation, to test the user's memory of the stored associated facts or definitions.

It is yet another object of the present invention to provide such a learning tool that simulates the shuffling of a deck of flash cards and selecting a card that contains related information on each side.

It is but another object of the present invention to provide such a learning tool that permits recalled audio information that has not been memorized correctly to be recycled into a random testing queue so that the student is re-tested on the saved information.

It is still another object of the present invention to provide such a learning tool that removes from the testing queue voice record information that has been previously tested and answered correctly.

It is but another object of the present invention to provide such a learning tool that allows the optional downloading of its voice memory from a remote source so that an individual such as a teacher can record a spelling or vocabulary list into a master Programmable Self Teaching Audio Memorizing Aid, or retrieve such information from a CD or website and then download the recorded word lists into student's devices, for self testing and memorizing of the stored information.

To the accomplishments of the foregoing objects and advantages, the present invention, in brief summary, comprises a programmable electronic device for storing, retrieving and playing back audio information stored as audio information pairs within an analog or digital voice memory. The audio information pairs are stored as voice records and are ordered in a queue, with each record being individually addressable by a microcontroller and a voice record pointer. Individual audio information pairs may be randomly selected by the microcontroller or, alternatively, sequentially selected in the order they were stored in the queue. Either the first or second audio segment in the audio information pair may be played and, if the information contained in the corresponding segment is known (for example the word's definition or the state's capital), the record may be removed from the queue and another audio information pair accessed. Alternatively, if the information from the corresponding record is not known, the corresponding audio segment may be played, and the audio information pair placed back in the queue. Each audio information pair may be edited and new pairs added by means of a microphone, or, alternatively, from an external source such as a CD-ROM or a database accessed over a computer network such as the Internet.

The electronic learning tool of the present invention is an easy-to-use programmable memorizing learning aid that helps kids and adults learn and memorize vocabulary words, foreign language, spelling, math, and associated facts (such as states and their capital cities). Because it is user programmable, its applications are limitless. The tool operates like a stack of programmable audio flash cards. Audio information is recorded and stored in ordered pairs: vocabulary words and their definitions, foreign language words/phrases and their translation, words and their spelling, math problems and answers, or associated facts, such as the names of explorers and what they discovered. Stored information pairs may be retrieved sequentially (in the same order as recorded) added to or edited, or they may be retrieved randomly, in a self-test mode, to learn the associated facts, vocabulary definitions, etc. The random access mode is similar to shuffling a deck of flash cards and selecting a card that contains related information on both sides. Information that is not remembered correctly may be saved and recycled into the random testing queue so that the student is re-tested on the saved information.

To record an ordered audio information pair, the RECORD switch is pressed which lights the red LED, indicating record mode. Holding the RECORD switch for more than one second clears the voice memory for a new recording. Pressing the WORD switch selects the shorter side of an ordered information pair, up to 1.75 seconds in length, while pressing the DEF (definition) switch selects the longer side of the audio ordered pair, up to 3.5 seconds in length. By way of example, in order to record words and their definitions, a user may press WORD and record a vocabulary word while the LED is green, indicating recording is in progress, then press DEF to record the associated definition. In a similar manner words and their spelling, associated facts, math problems, or foreign language words and translations may be recorded. The DEF switch key may be pressed first to record the definition, followed by the WORD key. Each time an ordered audio information pair is recorded, the electronic learning tool advances the record pointer to the next voice record in its audio memory.

To edit a previously recorded vocabulary list, a user may press the SEQ RECALL (sequential recall) switch, which selects Sequential Playback Mode. This permits access to stored audio pairs in the same order that they were recorded. If the SEQ RECALL switch is held for more than one second, the voice record pointer is reset to the start of the stored information list. When in a playback mode, the LED is not lit. Once in Sequential Recall Mode, pressing WORD or DEF permits sequencing through the stored audio pairs. To record over a previously recorded audio information pair, a user presses the RECORD switch once, to select Record Mode. The user then need only press WORD or DEF to record over previously recorded information. When the new recording is finished, the user may then switch back to Playback Mode. Note that while in Sequential Recall Mode, when the end of a recorded list of audio pairs is reached, the electronic learning tool will wrap around back to the first audio record. To add additional audio pairs to the end of a previously recorded list, the user need only advance to the last recorded pair while in Sequential Recall Mode, then press the REC key twice (which causes the voice record pointer to advance to the next record, rather than recording over the current record), then press WORD or DEF to record new audio information which will be appended to the end of a previously recorded list.

To learn and/or memorize the information stored as audio information pairs, the user may press the RAND RECALL (random recall) switch, which Selects Random Recall Playback Mode. Each time the WORD switch is pressed, the electronic learning tool randomly retrieves one half of a stored audio information pair from its voice memory to test the user's recall of information recorded in the other half of the stored audio pair. If the vocabulary definition, spelling, or fact is known, pressing WORD again advances to another randomly selected ordered pair. If not, pressing the DEF switch retrieves the unknown information. If the user wishes to be re-tested on unlearned information, he may press SAVE, which causes the current ordered audio pair to be recycled into the voice memory queue. Otherwise, once a voice record is accessed in Random Recall Playback Mode, it is removed from the queue of available voice records from which information pairs are randomly selected. Note that new voice records can also be selected using the DEF switch first, to randomly fetch a stored definition or longer fact, to see if the user remembers the associated word or shorter associated fact.

The electronic learning tool of the present invention also includes a provision to allow its voice memory to be downloaded from another device. This is useful in school applications so that a teacher can record a spelling or vocabulary list into a master database, or use pre-recorded media such as CD-ROM, and download the recorded word lists into student's electronic learning tools, for self-testing and memorizing of the stored information. There are several ways this download could be accomplished, including via plug-in or hardwire connection in the classroom, or via the Internet or telephone line. In the case of downloading pre-recorded word lists, the electronic learning tool could include a small LCD display, to display words and definitions or facts, to visually complement retrieved audio information.

### BRIEF DESCRIPTION OF THE DRAWINGS

FIG. 1 is a perspective drawing of the physical appearance of a hand-held Programmable Self Teaching Audio Memorizing Aid of the present invention;

FIG. 2 is a schematic diagram of the electronic circuit of the Programmable Self-Teaching Audio Memorizing Aid;

FIG. 3 is a top-level conceptual flow diagram of the operation of the invention; and

FIGS. 4, 5, and 6 are detailed flow diagrams of the microcontroller software control logic which implements the functionality and unique features of the present invention.

### DETAILED DESCRIPTION OF THE PREFERRED EMBODIMENTS

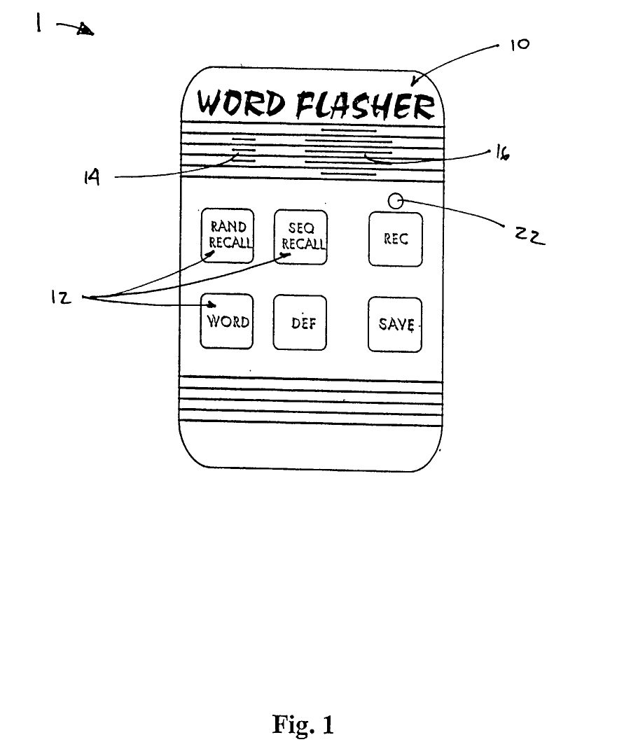

With reference now to the figures and in particular with reference to FIG. 1, there is shown a front view of the handheld version of the electronic learning tool of the present invention, referred to generally by reference number 1. This preferred embodiment consists of a housing 10 upon which are disposed a plurality of pushbutton control switches 12, and further including apertures 14, 16 for an electet microphone 18 and loudspeaker 20, respectively. A bicolor LED 22 is also disposed on the housing 10, which LED 22 flashes different colors to indicate the various modes of operation of the learning tool 1.

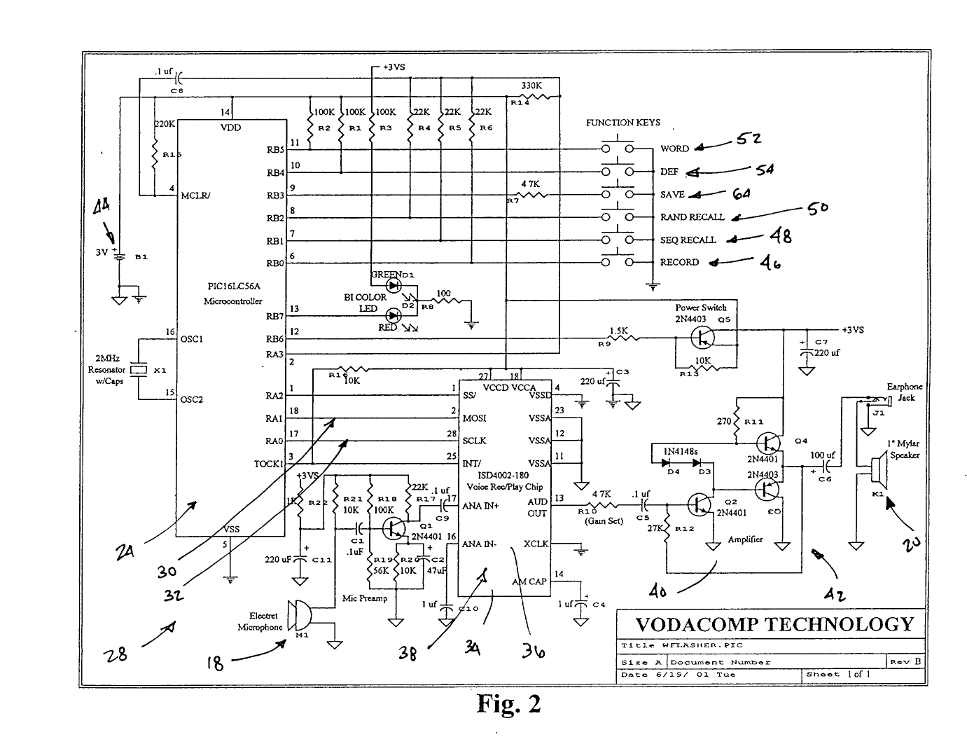

Referring to the electronic circuit diagram of FIG. 2, the features and control logic of the electronic learning tool 1 of the present invention are implemented in a microcontroller 24. In the preferred embodiment of the present invention, the microcontroller 24 consists of a Microchip Technology PIC16C56 microcontroller, which includes 1K of program memory and twelve I/O lines. However, it should be appreciated that other microcontrollers with similar features would also serve equally to control the functions of the learning tool 1.

The microcontroller 24 serves to scan the pushbutton switches 12 and control the bi-color LED 22, which indicates when the device is in record mode by flashing red, and when audio recording is in progress by flashing green. The microcontroller 24 also controls the voice memory 26 by means of a control interface 28 consisting of serial data lines 30 and clock lines 32. In the preferred embodiment of the invention, the voice memory 26 consists of a three minute analog voice memory array 34, implemented in an Information Storage Devices (ISD) nonvolatile voice record/playback chip 36, as shown in FIG. 2. The voice record/playback chip 36 includes addressable voice memory segments 38, the addresses of which are sent to the ISD chip 36, along with record/playback commands, from the microcontroller 24 through the control interface 28. Alternatively, the voice memory feature of the learning tool 1 could also be digitally implemented, which has the advantage that once audio information is recorded in the memory, it could be accessed by multiple users simultaneously by time sharing access to the digital voice memory, so that a multi-user version of the present invention could be constructed. A single chip combination microcontroller and digital voice memory can also be used in this invention. The digital voice memory may be implemented in a memory chip utilized with an audio codec or, alternatively, within a digital voice record/playback chip, which includes a combination microcontroller and digital voice memory.

In the preferred embodiment, the ordered pair of stored audio information consists of a short segment, which is approximately 1-2 seconds in length and is usually used to record words, and a longer segment, approximately 3-5 seconds which is usually used to store word definitions. Depending upon the specific function of the learning tool, however, the time frame for each segment may be altered so as to allow for less or more audio information to be stored. It should be appreciated, of course, that the longer the time frame for each audio segment, the fewer ordered pairs of audio information that may be stored within the voice memory 26. Since the voice memory array 34 in the preferred embodiment holds approximately three minutes of analog voice memory, the voice memory 26 can therefore hold around thirty correlated pairs of audio information.

The electronic learning tool 1 of the present invention also includes a preamplifier 40 which amplifies audio input from the microphone 18 for recording, and supplies an analog audio output which is amplified by a suitable external audio amplifier circuit 42 to drive the loudspeaker 20. Another function of the microcontroller 24 is to turn the power to external circuitry such as the microphone 18 and output amplifier 42 on and off, because the hand-held version of the present invention is powered by a battery 44. The learning tool 1 powers up automatically whenever the RECORD switch 46, SEQ RECALL switch 48, or RAND RECALL switch 50, are pressed and powers down after a timeout when the device is not in use.

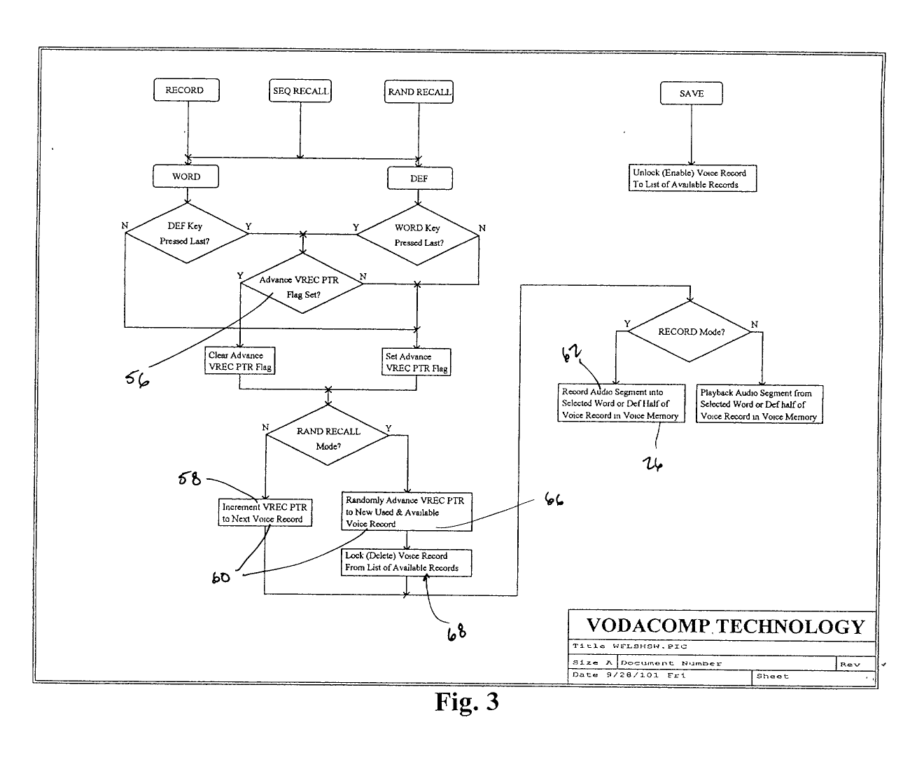

FIG. 3 shows the conceptual operation of the learning tool 1 of the present invention. Use of the tool 1 is commenced by selecting one of three modes of operation: (1) Sequential Recall Mode, in which ordered pairs of information are presented in sequential order, which mode is selected by depressing the SEQ RECALL switch 48; (2) Random Recall Mode, in which ordered pairs of information are presented in random order, which mode is selected by depressing the RAND RECALL switch 50; and Record Mode, in which new data is input, which mode is selected by depressing the RECORD switch 46. Following selection of the mode, either the WORD switch 52 or the DEF switch 54 is pressed to select one side of an information pair. Whichever side is selected first sets the Advance Voice Record Pointer Flag 56 and advances the Voice Record Pointer 58 to a new Voice Record 60. If the other side of the information pair is selected, the Advance Voice Record Pointer Flag 56 is toggled, and audio information is recorded to or retrieved from the same Voice Record 60, without incrementing the Voice Record Pointer 58. If the original side of the pair is accessed again by pressing the same switch 12, the Voice Record Pointer 58 is advanced either to the next sequential Voice Record 60 in the event that the SEQ RECALL switch 48 was selected, or randomly to a new used and available Voice Record 60 in the event the RAND RECALL switch 50 was selected. The audio segment 62 from the selected side of the Voice Record 60 is then either recorded or played back. In Random Recall Mode, once either side of a Voice Record has been played back, the record is locked so that it will not be randomly retrieved again. Depressing the SAVE switch 64 unlocks the currently selected Voice Record 60 so that it becomes available again for random selection.

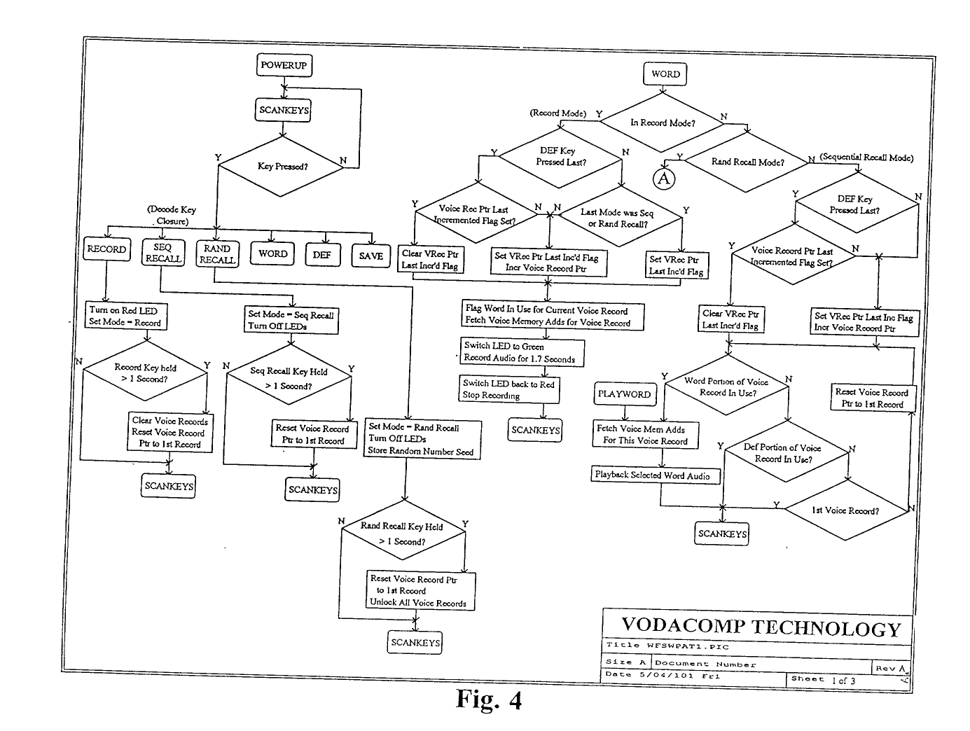

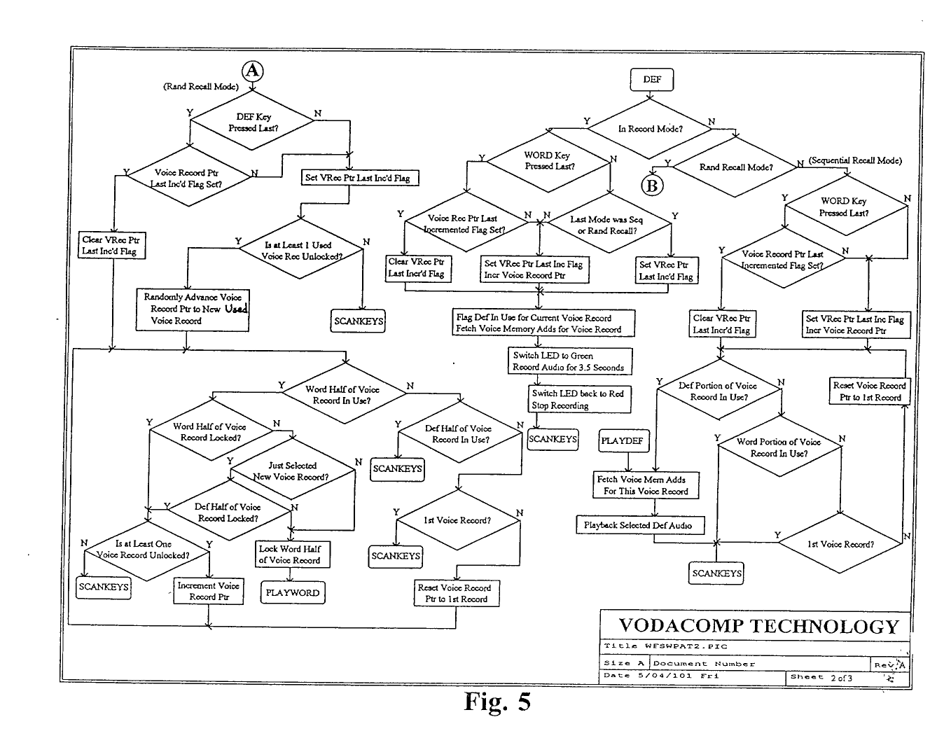

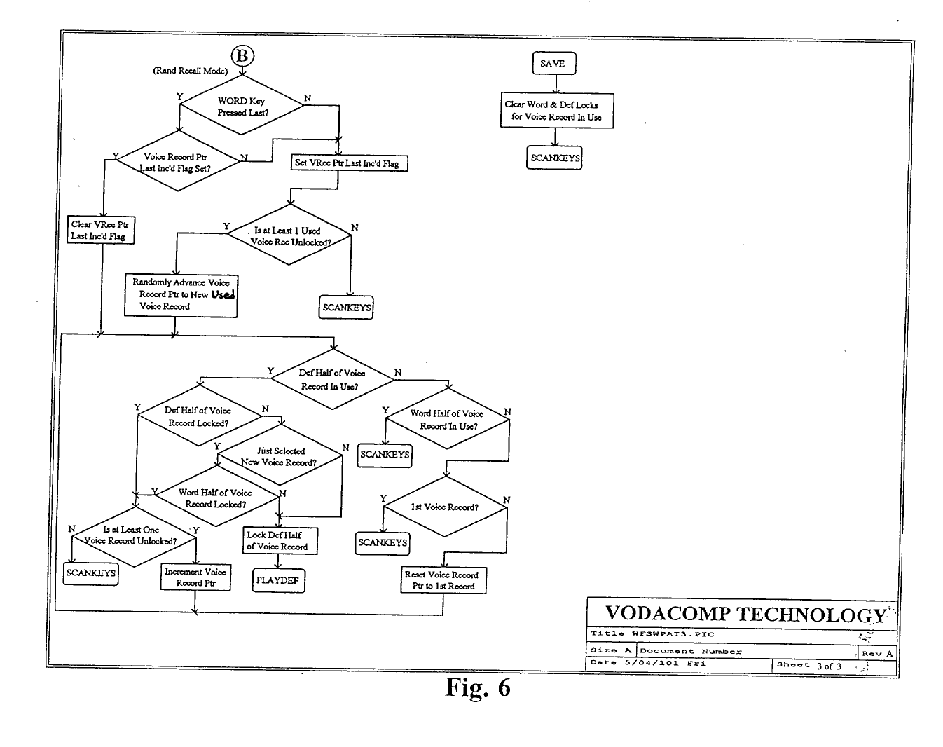

The detailed software logic responsible for the operation of the learning tool 1 of the present invention is illustrated in FIGS. 4, 5, and 6.

To record an ordered audio information pair 66, RECORD switch 46 is pressed, which lights the LED 22 red, indicating record mode. Holding the RECORD switch 46 for more than one second clears the voice memory 26 for a new recording. Pressing the WORD switch 52 or DEF switch 54 starts the actual recording of audio from the microphone 18. These two keys 52, 54 are conceptually equivalent to the two sides of a flash card. The WORD switch 52 selects the shorter side of an ordered audio information pair 66, up to about 1.75 seconds in length in the preferred embodiment of the invention. The DEF switch 54 selects the longer side of the ordered pair, up to about 3.5 seconds in length in the preferred embodiment. To record words and their definitions, for example, the WORD switch 52 is pressed and a vocabulary word recorded while the LED 22 is green, indicating recording is in progress. Then the DEF switch 54 is pressed to record the associated definition of the vocabulary word. In a similar manner words and their spelling, associated facts, math problems, or foreign language words and translations may be recorded. Of course, these are only a few of the examples of the applications for which the electronic learning tool 1 is particularly suited. Note that the DEF switch 54 may be pressed first to record the definition, followed by the WORD switch 52. Each time an ordered audio information pair 66 is recorded, the microcontroller 24 advances the record pointer 58 to the next voice record 60 in the voice memory 26.

To edit a previously recorded audio information list 68 of ordered information pairs 66, the SEQ RECALL switch 48 is pressed, which selects Sequential Playback Mode. This permits access to stored audio information pairs 66 in the same order that they were recorded. If the SEQ RECALL switch 48 is held for more than one second, the voice record pointer 58 is reset to the start of the stored information list 68. When in a playback mode, the LED 22 is not lit. Once in Sequential Recall Mode, pressing the WORD switch 52 or DEF switch 54 permits sequencing through the stored audio information pairs 66. To record over a previously recorded audio information pair 66, the RECORD switch 46 is pressed once, to select Record Mode. Then the WORD switch 52 or DEF switch 54 is pressed to record over previously recorded information. When the new recording is finished, pressing the SEQ RECALL switch 48 or the RAND RECALL switch 50 switches back to Playback Mode. Note that while in Sequential Recall Mode, when the end of a recorded information list 68 of audio pairs 66 is reached, the voice record pointer 58 wraps around back to the first audio pair record 66. To add additional audio pairs 66 to the end of a previously recorded list 68, the user advances to the last recorded pair 66 while in Sequential Recall Mode, then presses the RECORD switch 46 twice, which causes the voice record pointer 58 to advance to the next audio pair record 66, rather than recording over the current record 66. Pressing the WORD switch 52 or DEF switch 54 then permits the recording of new audio information which is appended to the end of a previously recorded list 68.

To learn and/or memorize the information of the ordered information pairs 66 stored in the voice memory 26 of the present invention, the RAND RECALL switch 50 is pressed to select Random Recall Playback mode. Each time the WORD switch 52 is pressed, the electronic learning tool 1 randomly retrieves one half of a stored audio information pair 66 from its voice memory 26, to test the user's recall of the information recorded in the other half of the stored audio pair 26. If the associated fact is known, pressing the WORD switch 52 again advances to another randomly selected ordered pair 66. If not, the DEF switch 54 may be pressed to retrieve the unknown information. If the user wishes to be re-tested on unlearned information, the SAVE switch 64 may be pressed, which causes the current ordered audio pair 66 to be recycled into the voice memory queue 70. Otherwise, once an audio pair voice record 66 is accessed, in Random Recall Mode, it is removed from the queue 70 of available voice records 60 from which information pairs 66 are randomly selected. Note that voice records 60 can also be selected using the DEF switch 54 first, to randomly fetch a stored definition or longer fact, to see if the user remembers the associated word or shorter associated fact.

Having thus described the invention with particular reference to the preferred forms thereof, it will be obvious that various changes and modifications can be made therein without departing from the spirit and scope of the present invention as defined by the appended claims. For example, the voice memory 26 may be downloaded from another external source such as a CD-ROM or global computer network such as the Internet. This feature is useful in school applications so that a teacher can record a spelling or vocabulary list into a master database, or use pre-recorded media such as CD ROM, and download previously recorded word lists into student's learning tools 1, for self-testing and memorizing of the stored information. The voice memory transfer can be accomplished via plug-in or hard wire connection in the classroom, or could be achieved remotely via the Internet or a telephone line. In the case of downloading prerecorded information into the present invention, a small LCD display may be included, that would display stored words and definitions or facts, to visually complement the stored audio information. Otherwise, use of a display requires the addition of a small alpha keyboard to the device, for manual entry of text information to complement the recorded audio. Such an addition is fully within the scope of operation of the invention.

What is claimed is:

1. A programmable electronic device for facilitating the learning and memorization of ordered pairs of audio information comprising first and second related audio records, said device comprising:
means for storing a plurality of said pairs of audio information;
means for accessing individual pairs of audio information;
means for playing one of said first audio record or said second audio record from said accessed pair; and
means for alternatively playing said other audio record from said accessed pair or accessing another of said pairs of audio information.

2. The programmable electronic device of claim 1, further including a microcontroller for controlling said means for storing, means for accessing and means for playing.

3. The programmable electronic device of claim 2, wherein said audio information pairs are stored as a series of voice records within addressable voice memory segments, said records being individually addressable by said microcontroller.

4. The programmable electronic device of claim 3, wherein said microcontroller includes means for randomly selecting said records.

5. The programmable electronic device of claim 3, wherein said microcontroller includes means for sequentially selecting said records comprising a voice record pointer flag and voice record pointer.

6. The programmable electronic device of claim 3, wherein said microcontroller includes means for adding new ordered information pairs comprising a voice record pointer flag and voice record pointer.

7. The programmable electronic device of claim 3, wherein said microcontroller includes means for editing said ordered information pairs.

8. The programmable electronic device of claim 3, wherein said records are arranged in a queue and said microcontroller includes means for identifying said individual ordered information pairs that have been played and alternatively removing said individual ordered information pairs from said queue or replacing said individual ordered information pairs in said queue.

9. The programmable electronic device of claim 1, wherein said means for storing comprises an analog voice memory array implemented in a non-volatile voice record/playback chip.

10. The programmable electronic device of claim 1, wherein said means for storing comprises a digital voice memory implemented in a memory chip utilized with an audio codec.

11. The programmable electronic device of claim 1, wherein said means for storing comprises a digital voice memory incorporated in a digital voice record/playback chip.

12. The programmable electronic device of claim 1, further including a microphone for receiving said pairs of audio information.

13. The programmable electronic device of claim 1, further including an electronic interface for receiving said pairs of audio information from an external source.

14. The programmable electronic device of claim 1, further including a plurality of control switches for operating said device.

15. The programmable electronic device of claim 1, wherein said means for playing comprises an audio speaker.

16. The programmable electronic device of claim 1, further including a visual display to show textual information pairs stored and correlated with said audio information pairs.

17. A programmable electronic device for facilitating the learning and memorization of ordered pairs of audio information comprising first and second related audio records, said device comprising:
a microcontroller;
means for storing a plurality of said pairs of audio information as a series of voice records within addressable voice memory segments, said records being individually addressable by said microcontroller, said means for storing further including an analog or digital voice memory implemented in a voice record/playback chip;
means for accessing individual pairs of audio information;
means for playing one of said first audio record or said second audio record from said accessed pair, said means for playing comprising an audio speaker;
means for alternatively playing said other audio record from said accessed pair or accessing another of said pairs of audio information; and
means for adding new ordered information pairs comprising a voice record pointer flag and voice record pointer controlled by said microcontroller;
wherein said records are arranged in a queue and said microcontroller includes means for identifying said individual ordered information pairs that have been played and alternatively removing said individual ordered information pairs from said queue or replacing said individual ordered information pairs in said queue.

18. A method for facilitating the learning and memorization of ordered pairs of audio information comprising first and second related audio records, said method comprising the steps of:
providing a programmable electronic learning device comprising:
a microcontroller;
means for storing a plurality of said pairs of audio information as a series of voice records within addressable voice memory segments, said records being individually addressable by said microcontroller, said means for storing further including an analog or digital voice memory implemented in a voice record/playback chip;
means for accessing individual pairs of audio information;
means for playing one of said first audio record or said second audio record from said accessed pair, said means for playing comprising an audio speaker;
means for alternatively playing said other audio record from said accessed pair or accessing another of said pairs of audio information; and
means for adding new ordered information pairs comprising a voice record pointer flag and voice record pointer controlled by said microcontroller;
wherein said records are arranged in a queue and said microcontroller includes means for identifying said individual ordered information pairs that have been played and alternatively removing said individual audio information pairs from said queue or replacing said individual audio information pairs in said queue;
storing at least one audio information pair;
accessing said audio information pair;
playing said first record of said audio information pair;
alternatively playing said second record of said audio information pair and replacing said audio information pair in said queue, or removing said audio information pair from said queue and access another of said audio information pairs.
